(19) United States
(12) Patent Application Publication
(10) Pub. No.: US 2004/0202505 A1
(43) Pub. Date: Oct. 14, 2004

(54) Two-piece, high performance swivel connector

(76) Inventor: Ferro Francesco Pagliai, (US)

Correspondence Address: JONES DAY, Suite 4600, 555 W. Fifth Street, Los Angeles, CA, 90013-1025, US

(21) Appl. No.: 10/414,454

(22) Filed: Apr. 14, 2003

(51) Int. Cl. F16L 5/00

(52) U.S. Cl. 403/78

(57) ABSTRACT

A simple, two piece, easily machined and assembled swivel connector that provides an extremely durable, water-tight connection between a standard pipe thread connection on one end and a standard garden hose connector on the other end that will allow for fluid communication throughout a 360-degree rotation of the upper piece of the swivel relative to the lower piece, and for ease of rotation.

### BACKGROUND OF THE INVENTION

This invention relates generally to swivel connectors, and specifically to a swivel connector that is intended for extended, high performance use in conjunction with a garden hose reel.

The ubiquitous garden hose is in many ways a necessary evil. While they essentially perform only a single function, which is to convey a largely continuance flow of pressurized water from point A to point B, the different circumstances in which that must be done are simply too numerous to list. Just around the typical home, the garden hose is not just used to water the garden as the name would suggest, but is used for innumerable other things from washing the car, to washing the windows, to washing the dog, to hosing off the sidewalks and driveways, to filling this or that with water, to even being a “weapon” in summertime water fights. Indeed, most homes have at least two, three or even more garden hoses attached to their exterior water outlet bibs at all times.

However, the garden hose can also be as maddening as it is useful. They are unsightly unless neatly coiled. But trying to neatly coil a garden hose, and particularly a lengthy one, and particularly on a cool or cold day, seemingly requires the skill and strength of a longshoreman. Even if neatly coiled after each use, the coil is still usually in the way to be stumbled over; and even if neatly coiled, the next time it is extended it tends to twist and kink, causing the uncoiling to be an exercise in frustration as the hose, and the water flow, abruptly stops.

For all these reasons and more, the hose reel was invented. The conventional hose reel, as the name suggested, is used to store the hose on something akin to a fishing reel, to and from which it can be reeled in and reeled out easily and without the fuss, muss, coils and kinks encountered otherwise. The number of types and sizes of hose reels is also great. But the one thing every single hose reel has is a connector between the female end of the hose and a fitting on the hose reel. Because by definition a hose reel rotates whereas the water spigot is stationary, somewhere within the system some means must be provided that will account for that fact. In some hose reels, the end of the garden hose attaches to the actual stationary external hose bib by means of an attachment device that is supposed to allow the hose to rotate on the bib. The emphasis is on “supposed to” because historically those devices do not work very well and the result is either a twisted hose or an attachment device that leaks profusely, or most often both. In other hose reels, the end of the hose attaches to a separate hose bib, usually located somewhere on the interior area of the reel, and that separate hose bib either has an attachment means that is supposed to rotate, or there is a short hose that extends from it to another connection that is supposed to rotation. The result is typically the same—a leaky connection and a kinked hose.

Therefore, there exists a need in the art for an improved swivel connector for use with hose reels.

### SUMMARY OF THE INVENTION

The device of this invention provides such a solution in a simple, two-piece, easily machined and assembled connector that has standard pipe threads on one end and standard hose threads on the other. It provides an extremely durable, water-tight connection throughout a full 360-degree free rotation.

The device comprises a substantially elongated upper piece having a uniform diameter transverse bore extending completely through it, and a longitudinal bore extending from that transverse bore out to the distal end of that piece, which end also has standard garden hose threads. A substantially elongated lower piece is fully rotatably attached to the upper piece, with the lower piece having an exterior diameter and overall length such that it snuggly fits into and extends slightly through the transverse bore in the upper piece when fully inserted therein. A transverse bore in the lower piece registers with the transverse bore in the upper piece, and with a channel around the periphery of the lower piece so that there is fluid communication between the lower piece transverse bore and the upper piece longitudinal bore regardless of the orientation of the upper piece relative to the lower piece. A longitudinal bore in the lower piece extends up to intersect with the other bores to create fluid communication through the entire device once assembled. There are standard pipe threads on the distal end of the lower piece.

The device of this invention is intended primarily for use with those hose reels in which the reel rotates about a central, hollow, stationary axle. One end of the axle is fitted with a standard, stationary female hose connector, and a short hose from the stationary hose bib on the water supply spigot attaches to that female connector in the usual way. The other end of the central hollow axle is outfitted with a standard female pipe threaded fitting, so that the pressurized water supply is fed through the central axle to that female pipe threaded fitting. The male pipe-threaded end of the device of this invention is attached to that female fitting, leaving the hose-threaded other end of the device for attachment to the end of the hose that is wrapped around the reel. As the reel is rotated, the portion of the device that is attached to the stationary axle also remains stationary, while the portion of the device attached to the reeled hose freely rotates, creating a 360-degree freely rotatable, strong and leak-free connection that allows the hose to be reeled out and in easily without creating twists and kinks in the hose or leaks at the connector universally encountered with the prior art devices.

### DESCRIPTION OF THE FIGURES

FIG. 1 is a perspective view of the swivel connector of this invention.

FIG. 2 is a side view of the invention showing the preferred exterior configuration and the preferred 90-degree orientation of the device's upper and lower pieces, and showing how a portion of the lower piece protrudes above the upper piece, where a simple snap ring is used to hold the two pieces together. This Figure also highlights the overall compactness of the device.

FIG. 3 is a top view of the invention showing the preferred substantially rectangular shape of the upper piece and the position of the snap ring.

FIGS. 4A and 4B are section views taken along line 4-4 in FIG. 3 and showing the device with the lower piece rotated 90-degrees from FIG. 4A to FIG. 4B. FIGS. 4A and 4B also show the elegant simplicity of the interior design that will allow for ease of manufacture and assembly, and for durable use.

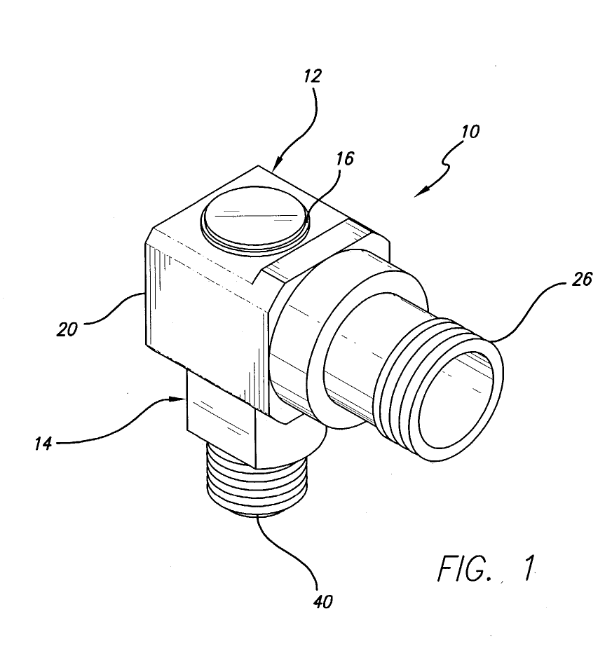

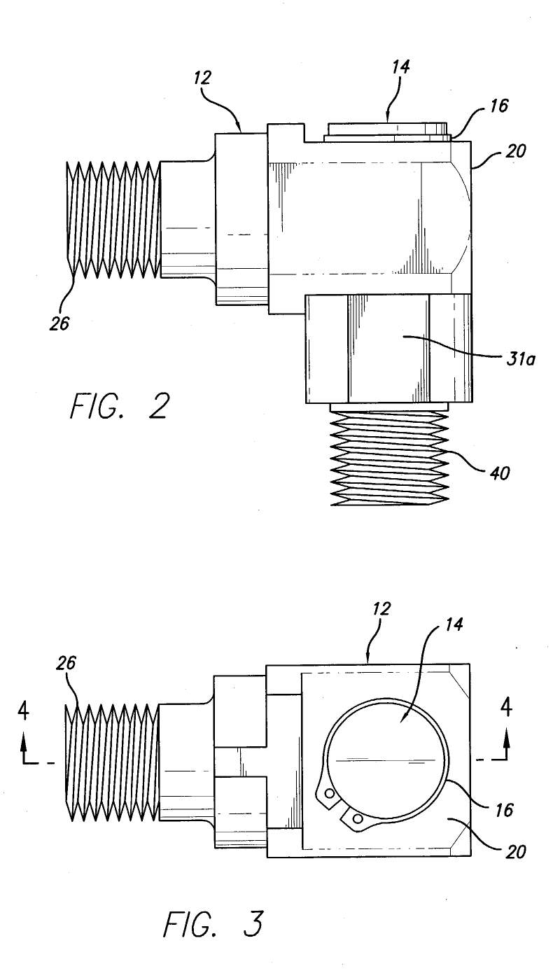

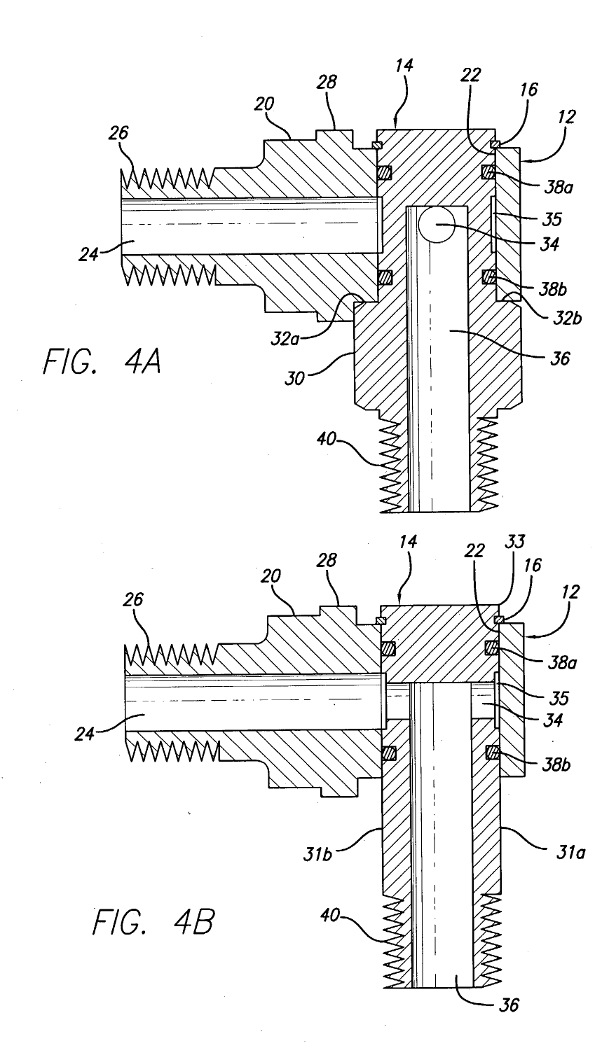

### DESCRIPTION OF THE PREFERRED EMBODIMENT

As shown in the Figures, the preferred embodiment of the device 10 of this invention is substantially of two-part construction, comprising an elongated upper piece 12 and an elongated lower piece 14. Both pieces are preferably made of metal, and stainless steel and brass work well, although brass is preferred.

The upper piece 12 has a substantially rectangular main body section 20 (approximately 1 1/4 inch on all sides) at one end thereof through which a straight bore 22 of uniform diameter (approximately 3/4 inch diameter) is drilled transversely. A longitudinal straight bore 24 (approximately 5/8 inch diameter) extends for the other end of upper piece 12 and terminates at transverse bore 22, providing for fluid communication between them. To improve the strength of upper piece 12, longitudinal bore 24 can have a stepped-down diameter as it approaches transverse bore 22 so as to leave more solid material in and about the stress point between the two pieces 12 and 14. Of course, the dimensions provided can be varied to suit the precise needs of the application for the device.

The upper piece 12 has an enlarged center section 28 also to provide added strength at a stress point. The distal end of the upper piece 12 has standard ¾-inch hose threads 26.

The elongate lower piece 14 is substantially cylindrical in exterior configuration except that it has an enlarged central section 30 that is also substantially cylindrical in exterior configuration except that two of its sides have flat sections 31a and 31b to accommodate the jaws of a standard wrench for insertion and removal of the overall device 10. The enlarged central section 30 also provides shoulders 32a and 32b that abut against the underside of the main body 20 of the upper piece 12 upon proper and full insertion of the lower piece 14 into the upper piece 12. Upon such proper and full insertion, a small portion 33 of the lower piece 14 protrudes above the main body 20 where snap ring 16 fits into an appropriately sized and positioned channel to hold lower piece 14 and upper piece 12 together without in any way restricting the rotational movement of one relative to the other.

There is a transverse bore 34 that extends entirely through the top portion of lower piece 14 and terminates within a channel 35 the extends entirely around the periphery of the lower piece 14. The location of the bore 34 and channel 35 are such that when lower piece 14 is properly and fully inserted within upper piece 12, transverse bore 34 and channel 35 align with longitudinal bore 24 in the upper piece 12 so that there is fluid communication between them regardless of the rotational orientation of lower piece 14 within upper piece 12.

There is a longitudinal bore 36 within lower piece 14 that extends from the distal end of the piece 14 all the way up to the transverse bore 34. Although bore 36 is shown in the drawings as being of a uniform diameter, it too can be reduced as it approaches the bottom of body 20 so as to provide more solid material at that stress point. Bore 36 is preferably about 1/2-inch in diameter.

To eliminate water leakage, two O-rings 38a and 38b are placed in appropriately sized channels on either side of the transverse bore 34 and channel 35 one the lower piece 14. The exterior of the distal end of lower piece 14 is fitted with standard pipe threads 40, in this instance, ½-inch-14-NPT threads.

It will be noted that upper piece 12 and lower piece 14 can be manufactured very easily as there are very few machining steps required. Similarly, assembly of the two pieces 12 and 14 together is extremely easy, requiring only three steps—1) slip the O-rings 38a and 38b into their respective channels; 2) push lower piece 14 fully into upper piece 12; and 3) insert the snap ring 16 into place. The device 10 is now ready for installation and use, and because it has standard hose threads on one end and standard pipe threads on the other, it can be readily used in a majority of applications without the need for other reducers or adapters. Moreover, because of the solid, compact, easily-machined metal design, the device works extremely well and is extremely durable.

Although the preferred embodiment has been shown in the attached Figures and described in detail above, the coverage provided by this patent is not to be limited to those embodiments expressly depicted and described, but is of the full scope of the following claims.

1. A two-piece swivel connector comprising:
a) a substantially elongated upper piece having a first end, a second end and a middle section; a transverse bore extending completely through said second end; a longitudinal bore extending from said first end in fluid communication with said transverse bore; and standard garden hose threads formed exteriorly on said first end; and
b) a substantially elongated lower piece fully rotatably attached to said upper piece, said lower piece having a first end, a second end and a middle section, said first end having an exterior diameter and overall length such that it snuggly fits into and extends slightly through said first bore in said upper body piece when fully inserted therein, said first end further having a central portion of substantially smaller exterior diameter so as to create an exterior channel around its periphery in register with said transverse bore in said upper piece; at least a portion of said middle section having a greater diameter than said first end such that it acts to restrict the insertion of said first end of said lower piece into said upper piece, and said second end having exterior standard pipe threads; said lower piece further having a longitudinal bore extending from said second end a sufficient distance into said lower piece such that it intersects the plane of said longitudinal bore in said upper piece when said lower piece is fully inserted therein; and at least one transverse bore in the reduced diameter portion of said first end, such that there is fluid communication at all times between the bores in said upper and lower pieces when said lower piece is fully inserted into said upper piece; and said lower piece lastly having at least two O-rings residing in appropriately sized exterior o-ring channels on either side of said lower piece transverse bore so as to create a water-tight seal between said upper piece and said lower piece.

2. The invention of claim 1 further including a snap ring that fits into an appropriated sized channel in the portion of said first end of said lower piece that extends exteriorly of said upper piece.

3. The invention of claim 1 in which said upper piece and said lower piece are at substantially right angles to one another.

4. The invention of claim 1 in which said upper and lower pieces are constructed of metal.

5. The invention of claim 4 in which said metal is brass.

6. Then invention of claim 4 in which said metal is stainless steel.

7. The invention of claim 1 in which said upper piece further has a middle section of increased exterior size adjacent the junction point between the two pieces.

8. The invention of claim 1 in which said longitudinal bores of are uniform diameter.

9. The invention of claim 1 in which said longitudinal bores have one or more reductions in diameter as they extend into said upper piece and said lower piece, respectively.
